(19) United States
(12) Patent Application Publication
(10) Pub. No.: US 2006/0074669 A1
(43) Pub. Date: Apr. 6, 2006

(54) Speech grammars having priority levels

(75) Inventor: Esa H. Seppala, Tampere (FI)

Correspondence Address: WARE FRESSOLA VAN DER SLUYS &;ADOLPHSON, LLP, BRADFORD GREEN BUILDING 5, 755 MAIN STREET, P O BOX 224, MONROE, CT, 06468, US

(73) Assignee: Nokia Corporation

(21) Appl. No.: 10/949,699

(22) Filed: Sep. 23, 2004

(51) Int. Cl. G10L 15/18

(52) U.S. Cl. 704/257

(57) ABSTRACT

In a speech recognition environment where time constraint limits the use of stored grammars in matching with a speech, the phonemes converted words are built into a number of trees of different priority levels so that the number of the trees combined into a concatenated tree for speech recognition is based at least partly on the time constraint. The trees of a lower priority level are used only when the time constraint allows such use and the trees of a higher priority level are used at least partly prior to the trees of a lower priority level being used.

### FIELD OF THE INVENTION

The present invention relates generally to speech recognition and, more particularly, to speech recognition using speech grammars based on pronunciation trees.

### BACKGROUND OF THE INVENTION

One of the currently used speech recognition methods is based on grammar trees. A grammar tree can be considered as a phonetic hidden Markov model (HMM). With such a tree structure, a grammar probability is used upon recognition of each phoneme of a word before recognition of the entire word is completed. Schwartz et al. (U.S. Pat. No. 5,621,859) discloses a method of speech recognition wherein a single tree-structure HMM with a large vocabulary is used for speech recognition. Such a large phonetic tree associated with the English language typically contains between forty to fifty initial branches. Each of the branches of the phonetic tree is associated with a phoneme. A word is associated with the end of each branch that terminates a phoneme sequence that corresponds to a word. However, a phoneme sequence can correspond to more than one word. Moreover, a phoneme sequence that corresponds to a word can be included in a longer phonetic sequence that corresponds to a longer word. Thus, all words that include the same phoneme include a common branch in the phonetic tree.

In order to demonstrate how vocabularies are used to build one or more pronunciation trees, some vocabularies are shown in FIG. 1 as examples. The exemplary vocabularies are grouped into two categories: audio, auto, handsfree and radio are examples of voice command vocabularies, whereas Janina, Laura, Lea and Leo are examples of name-dialing vocabularies. As shown in FIG. 1, the English and Finnish vocabularies to be built into pronunciation trees are based on International Phonetic Alphabet (IPA).

FIG. 2 shows how the pronunciations of the vocabularies are built into a pronunciation tree according to a conventional method. As shown in FIG. 2, the eight pronunciations in the voice command vocabularies are merged with the eight pronunciations in the name-dialing vocabularies and then the merged vocabularies are grouped into branches if they have one or more phonemes at the beginning part of a word. For example, in FIG. 1, the pronunciations “audio” and “auto” in the first branch have two phonemes in common: “au”.

A pronunciation tree can be built or implemented using C-language as shown below:

typedef struct
{

uint16 NPronuns; // Number of pronunciations in tree
uint16 NPhonemes; // Number of phomenes in the tree
uint16 NMaxPronuns; // Maximum number of pronunciations
in tree
uint16 NMaxPhonemes; // Maximum number of phomenes in
the tree
Phoneme_t * PhonemeData; // Contains consecutively all
phonemes
PronunAccess_t * PronunAccess; // Mapping pronunciation to
its

phonemes.

} PronunTree_t;

where phoneme is

typedef
{

uint8 Phoneme ID:7; // phoneme identifier
uint8 Branch:1; // 1 branch in phoneme, 0 no branch

} Phoneme_t;

and pronunciation access information is

typedef struct
{

uint8 PrefixLen; // number of phonemes from the previous
pronunciation
uint8 PronunLen; // number of phonemes for this pronunciation
(excluding

prefix).

} PronunAccess_t;

To demonstrate how a pronunciation tree is formed and how pronunciation tree data is generally collected based on the above pseudo codes, the following examples of names are used: adrian, john smith, john doe and andreea. Each of the letters in each of the names, include the space between words, represents a phoneme index.

The corresponding pronunciation tree for these names is

adrian [symbol]
ndreen
doe_john
john_doe

[symbol]

smith

smith_john

The phoneme tree data in pseudo code is shown below. However, binary data buffer can be written by putting the values into a sequence.

```
NPronuns = 6
NPhonemes = 43
NMaxPronuns = 6
NMaxPhonemes = 43
PhonemeData[] =
{ {1,a}, {0,d}, {0,r}, {0,i}, {0,a}, {0,n},
  {0,n}, {0,d}, {0,r}, {0,e}, {0,e}, {0,a},
  {0,d}, {0,o}, {0,e}, {0,_}, {0,j}, {0,o}, {0,h}, {0,n},
  {0,j}, {0,o}, {0,h}, {0,n}, {1,_}, {0,d}, {0,o}, {0,e},
  {0,s}, {0,m}, {0,i}, {0,t}, {0,h},
  {0,s}, {0,m}, {0,i}, {0,t}, {0,h}, {0,_}, {0,j}, {0,o}, {0,h}, {0,n} }
```

| PronunAccess[] ={ | {0,6}, | // adrian |
|---|---|---|
| | {1,6}, | // andreea |
| | {0,8}, | // doe john |
| | {0,8}} | // john doe |
| | {5,5}, | / john smith |
| | {0,10} } | // smith john |

Due to recent advances in computer technology and speech recognition algorithms, speech recognition machines have become more power and less expensive. Computing speed and large memory storage render it possible to have a pre-compiled, single tree-structure in a speech recognition system.

The trend in speech recognition is to use independent speech recognizers that allow the user to add new recognition items without requiring user training. Instead, automated training is based on text input. However, it is not always clear how the user wants to say a name or a command. Thus, it is necessary to provide variants. The use of variants causes problems with real-time performance because the number of grammar items may rise rapidly. In a portable device such as a mobile terminal where memory storage and computing power is limited, the use of a large number of variants becomes more problematic. Moreover, the user usually is not able to choose between fast recognition with less variants and more accurate recognition at the cost of speed.

It is thus desirable and advantageous to provide a method and system for speech recognition where the real-time requirement and the accuracy in speech recognition can be balanced.

### SUMMARY OF THE INVENTION

The present invention uses a number of smaller pronunciation trees, instead of a single large tree for speech recognition. The grammar items for one text input can be divided into different priority levels using a ranking method. A pronunciation tree is then built for each priority level, one or more pronunciation trees of each grammar are combined and loaded to a recognizer back-end. Prior to recognition, the grammars are known and the total number of recognition items for each priority level can be counted. As such, the priority level satisfying real-time performance requirement can be chosen prior to recognition.

Thus, the first aspect of the present invention provides a method of organizing grammars for use in an electronic device, the grammars having grammar items organized into trees of ordered branches. The method comprises:

ranking at least a part of the grammar items according to a grammar rule;

sorting at least part of the grammar items into grammar groups of different priority levels based at least partly on the ranking; and

building at least one tree separately for the grammar groups.

According to the present invention, the organized grammars are used at least in speech recognition.

According to the present invention, the trees built from the grammar items in the grammar groups at a higher priority level are at least partly used in speech recognition prior to the trees built from the grammar items in the grammar groups at a lower priority level.

According to the present invention, one or more trees are combined into a single concatenated tree for speech recognition and the number of trees combined in the concatenated tree is at least partly based on a time constraint.

According to the present invention, one or more trees are combined into a single concatenated tree for speech recognition and the number of trees combined in the concatenated tree is based at least partly on whether the speech recognition is carried out in real-time.

According to the present invention, the grammar items are words expressed in a string of phonemes, and the ordered branches are organized at least based on one or more phonemes similar among the strings in different words.

According to the present invention, the grammars are ranked at least based on the length of the string.

According to the present invention, the grammar items are ranked also based on the number of sub-branches on a branch.

The second aspect of the present invention provides a software program product embedded in a computer readable medium, the software product having executable codes for building trees of ordered branches from a plurality of grammar items of a plurality of ranks, wherein the executable codes, when executed, perform:

sorting the grammar items into grammar groups of different priority levels based at least partly on the ranks of the grammar items; and

building the trees at least partly separately for the grammar groups.

According to the present invention, the organized grammars are used at least in speech recognition.

According to the present invention, the executable codes further perform combining one or more trees into a single concatenated tree for speech recognition and the number of trees combined in the concatenated tree is at least partly based on a time constraint.

According to the present invention, the trees built from the grammar items in the grammar groups at a higher priority level are used at least partly prior to the trees built from the grammar items in the grammar groups at a lower priority level in said combining.

According to the present invention, the grammar items are words expressed in a string of phonemes, and the ordered branches are organized at least based on one or more phonemes similar among the strings in different words.

According to the present invention, the grammars are ranked at least partly based on the length of the string.

According to the present invention, the grammar items are ranked at least partly based on the number of sub-branches on a branch.

The third aspect of the present invention provides a speech recognition system, which comprises:

a grammar management module for receiving grammar entries; and

a text-to-phonemes conversion module, operatively connected to the grammar management module, for converting the grammar entries into a plurality of phoneme strings, so as to allow the grammar management module to build a plurality of trees from the phoneme strings based at least partly on priority levels of the grammar entries.

According to the present invention, the speech recognition system further comprises:

a software program for combining at least some of said plurality of trees into a concatenated tree having branches of phoneme strings.

According to the present invention, the speech recognition system further comprises:

a recognition algorithm for matching components in a speech signal with the phoneme strings in the concatenated tree.

The fourth aspect of the present invention provides an electronic device comprising:

a voice input to allow a user to input spoken words in the electronic device; and

a speech recognition system for recognizing the spoken words based on speech features of the spoken words, the system comprising:

a grammar management module for receiving grammar entries; and

a text-to-phonemes conversion module, operatively connected to the grammar management module, for converting the grammar entries into a plurality of phoneme strings, so as to allow the grammar management module to build a plurality of trees from the phoneme strings based at least partly on priority levels of the grammar entries and to combine at least some of the trees into a concatenated tree for matching the concatenated tree with the speech features.

According to the present invention, the grammar entries are ranked at least partly based on the length of the string.

According to the present invention, the grammar entries are ranked at least partly based on the number of sub-branches on a branch.

According to the present invention, the number of trees combined in the concatenated tree is at least partly based on a time constraint in said speech recognition.

According to the present invention, the number of trees combined in the concatenated tree is at least partly based on the computation power of the electronic device.

According to the present invention, the electronic device comprises a mobile terminal or the like.

### BRIEF DESCRIPTION OF THE DRAWINGS

FIG. 1 shows example vocabularies in English and Finnish.

FIG. 2 is a chart showing how a typical pronunciation tree is built.

FIG. 3 is a chart showing how a plurality of smaller pronunciation trees of various priority levels are built, according to the present invention.

FIG. 4 is a chart showing how the smaller pronunciation trees can be concatenated to form a single larger tree.

FIG. 5 is a chart showing how the smaller pronunciation trees can be concatenated to form a larger tree based on priority levels.

FIG. 6 is a block diagram showing a speech recognition module, according to the present invention.

FIG. 7 is a flowchart showing the method of speech recognition, according to the present invention.

FIG. 8 is a block diagram showing an electronic device having a speech recognition module, according to the present invention.

### DETAILED DESCRIPTION OF THE INVENTION

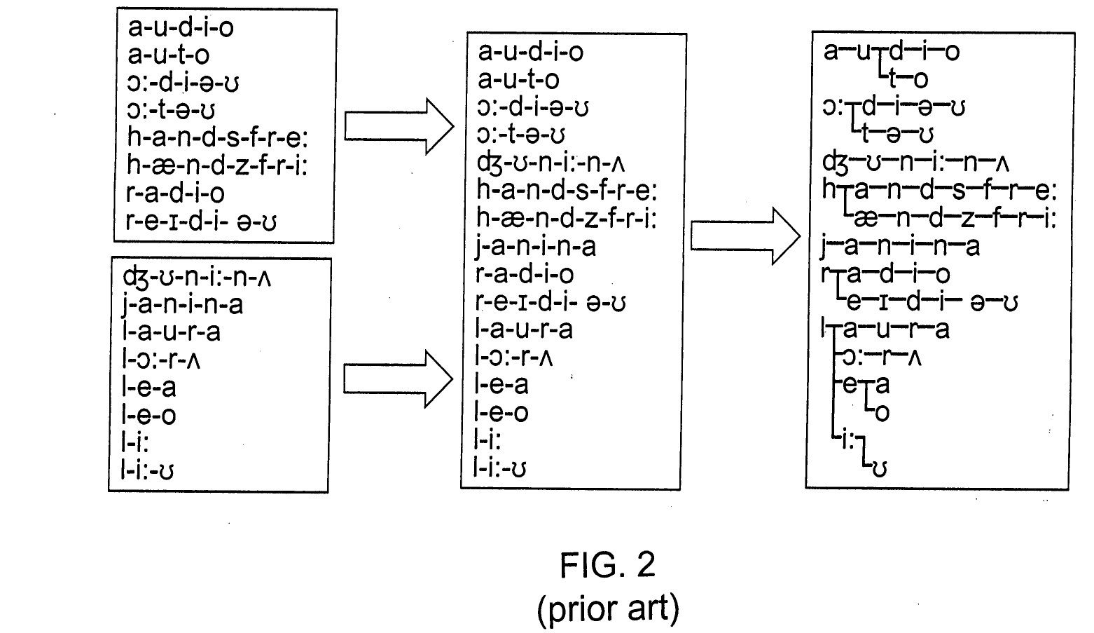

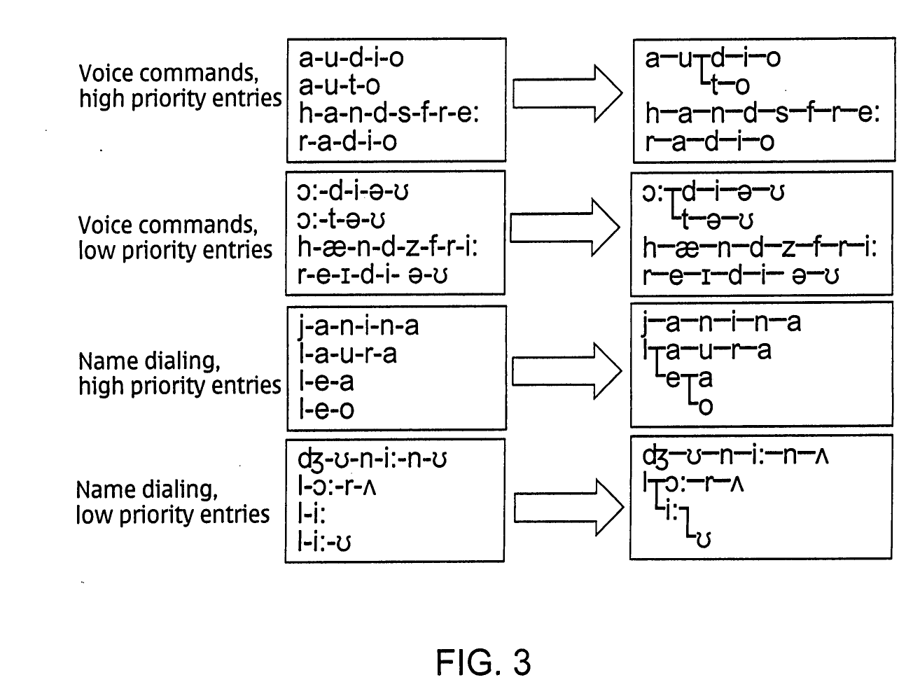

The present invention divides the pronunciations in a plurality of groups using priorities and builds a tree for each group. Unlike the tree building process as shown in FIG. 2, the pronunciations for the vocabularies in the voice command category are divided into two groups, based on the languages. Likewise, the pronunciations for the vocabularies in the name-dialing category are also divided into two groups. Assuming the speech recognition function is more likely to be used in association with the Finnish pronunciation than with the English pronunciation, the voice command and the name-dialing entries in Finnish belong to the higher priority group and those entries in English belong to the lower priority group. A separate tree is then built for each group, as shown in FIG. 3.

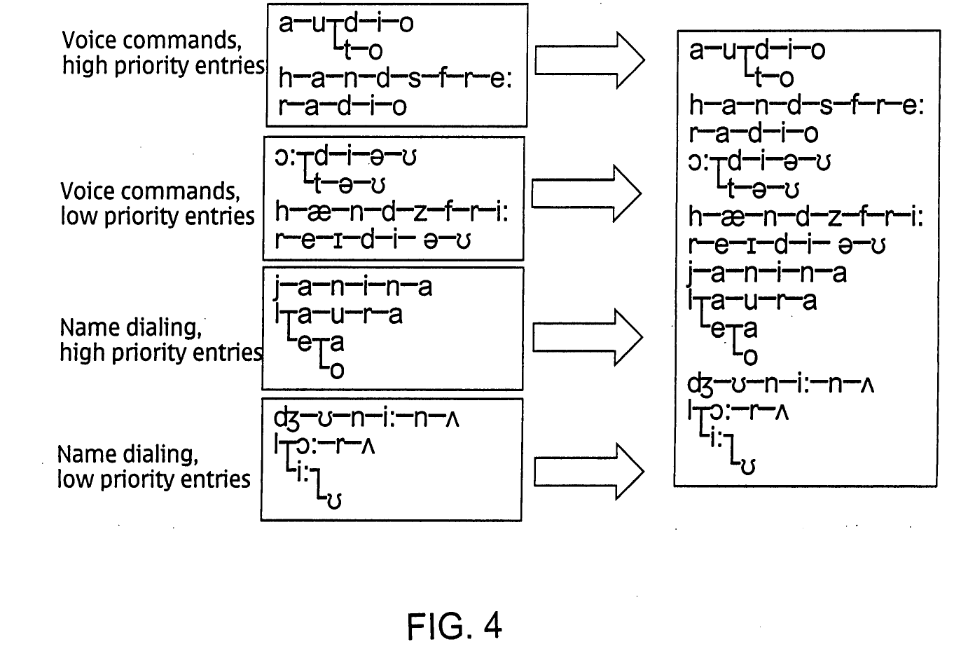

The usage of the separate trees is dependent upon the speed of speech recognition. If accurate recognition is desirable at the cost of speed, then both the higher priority entries and the lower priority entries are used. As shown in FIG. 4, all four separate trees are concatenated together into a single tree. The result is equivalent to the conventional recognition (see FIG. 2). The concatenating process can be carried out in real-time because it requires only copying.

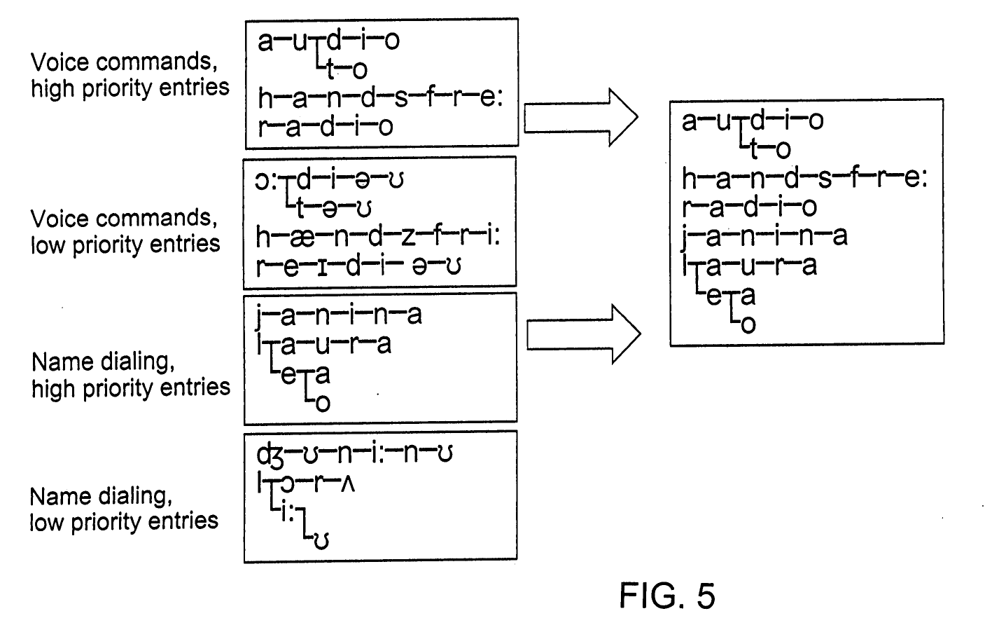

If the speech recognition function is required to be carried out substantially in real-time, then only the higher priority entries are used. As shown in FIG. 5, only the higher priority pronunciations (in Finnish) are selected for recognition. Accordingly, two separate trees of the higher priority level are concatenated into a smaller tree. In a device where only name-dialing is used, for example, then the fastest recognition can be achieved by using only the separate tree containing only the Finnish name-dialing entries. Thus, with the same grammar items for one text input, three or more recognition speeds can be selected.

To demonstrate how a pronunciation tree is formed based on priority and how pronunciation tree data is collected accordingly, the exemplary names of adrian, john smith, john doe and andreea are also used. However, it is assumed that the entries smith_john and doe_john have a lower priority than all other entries. They will be moved to a second tree (in italics, for clarity). The corresponding pronunciation trees for these names and the phoneme tree data are given below:

First tree:

adrian [symbol]
ndreea
john_doe

[symbol]

smith

Second tree:

doe_john
smith_john

The phoneme tree data:

| NPronuns = 4 or 6 | | |
|---|---|---|
| NPhonemes = 25 or 43 | | |
| NMaxPronuns = 6 | | |
| NMaxPhonemes = 43 | | |
| PhonemeData[] = | | |
| { {1,a}, {0,d}, {0,r}, {0,i}, {0,a}, {0,n}, | | |
| {0,n}, {0,d}, {0,r}, {0,e}, {0,e}, {0,a}, | | |
| {0,j}, {0,o}, {0,h}, {0,n}, {1,_}, {0,d}, {0,o}, {0,e}, | | |
| {0,s}, {0,m}, {0,i}, {0,t}, {0,h}, | | |
| {0,d}, {0,o}, {0,e}, {0,_}, {0,j}, {0,o}, {0,h}, {0,n}, | | |
| {0,s}, {0,m}, {0,i}, {0,t}, {0,h}, {0,_}, {0,j}, {0,o}, | | |
| {0,h}, {0,n} } | | |
| PronunAccess[] ={ | {0,6}, | // adrian |

| | |
|---|---|
| {1,6}, | // andreea |
| {0,8}} | // john doe |
| {5,5}, | / john smith |
| {0,8}, | // doe John |
| {0,10} } | // smith John |

With the above example, the priority level can be chosen by modifying the number of pronunciations (NPronuns) and the number of phonemes (NPhonemes). Other data remains the same. As such, the recognizer does not see the second tree if only the first one is chosen.

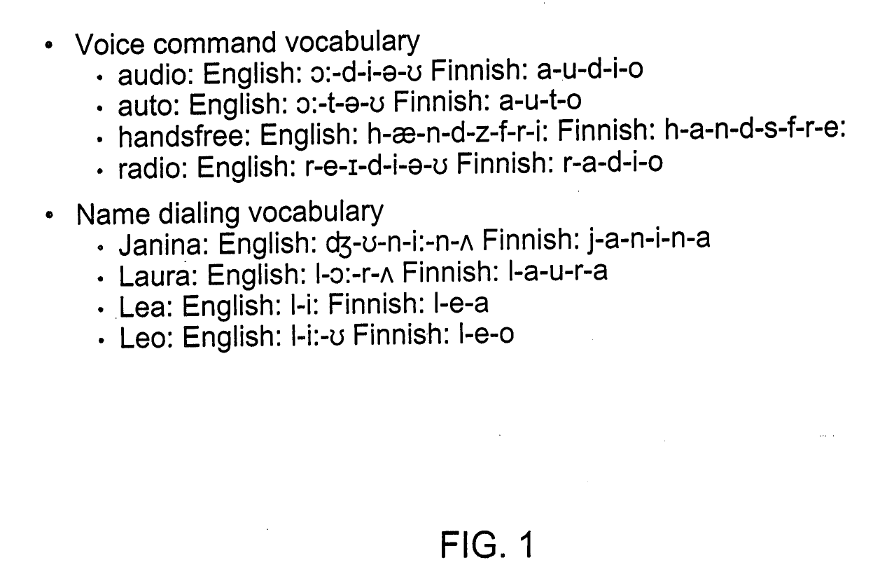

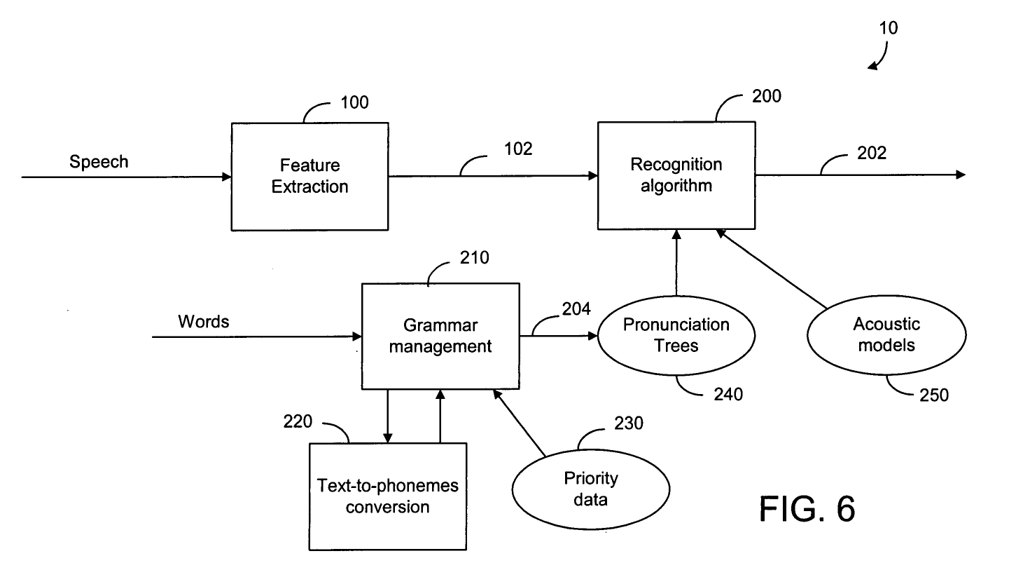

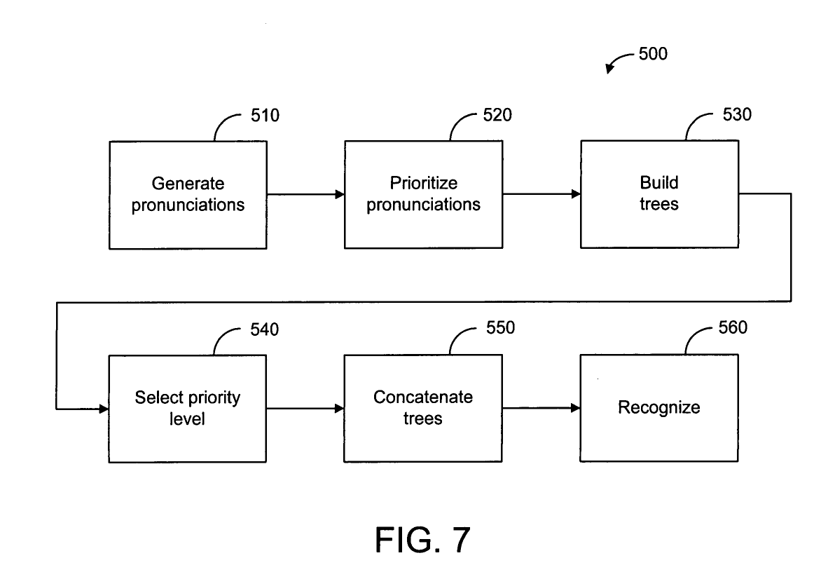

In general, the grammar items for one text input can be divided into different priority levels using a ranking method. A pronunciation tree is built for each priority level of the grammar. A pronunciation tree is considered as a set of ordered branches. This preparation process is shown in the upper flow of the flowchart 500 as shown in FIG. 7. More particularly, the preparation process includes three steps. At step 510, pronunciation is generated from vocabulary (see FIG. 1 and the left-most blocks in FIG. 2, for example). At step 520, the pronunciations are grouped according to priority entries (see the left-hand side of FIG. 3, for example). At step 530, trees are separately built from different priority entries in each category (see FIG. 3). The lower flow of the flowchart 500 illustrates three different steps. Based on the priority level as selected at step 540, one or more pronunciation trees of each grammar are combined at step 550. Examples of the combined or concatenated trees are shown in FIGS. 4 and 5. The concatenated trees are loaded into the recognizer backend (see FIG. 6) for speech recognition at step 560. Before recognition, the grammars are known and the total number of recognition items for each priority level can be counted. Thus, the priority level satisfying real-time performance can be chosen beforehand.

For speech recognition applications, according to the present invention, a speech recognition system 10 in FIG. 6 is used. As shown in FIG. 6, the speech recognition system 10 is divided into a feature extraction part and a recognition algorithm part. The feature extraction part takes place in a feature extraction module, or front-end 100. It uses known signal processing methods to compute feature vectors from a speech signal in order to provide a sampled speech buffer. These signal processing methods may comprise e.g. FFT, logarithms, MEL scaling, normalization or any applicable method, or any combination of these. The feature vectors are denoted by reference numeral 102. The actual recognition algorithm 200, also called a back-end, performs pattern matching between feature vectors and a model, which is created based on pronunciation trees 240 and acoustic models 250. Except for the pronunciation trees 240, which are built based on priority data 230, according to the present invention, the recognition algorithm based on the acoustic models 250 is known in the art. Thus, the present invention does not require any changes to front-end and back-end modules. The output 202 of the recognition module is known as recognition hypothesis.

In addition to modules 100 and 200, the speech recognition module 10 also includes components for managing grammars and text-to-phonemes conversions. The grammar management module 210 is responsible for saving vocabulary (based on words provided to module 210) and converting the vocabulary into pronunciation tree format using a text-to-phonemes conversion algorithm 220. An example of the text-to-phonemes conversion algorithm is shown in C-language pseudo-codes as described earlier in the background section. Unlike the tree building process in a conventional speech recognition system, the pronunciation trees 240 built by the grammar management module 210, according to the present invention, use priority data 230 for prioritization.

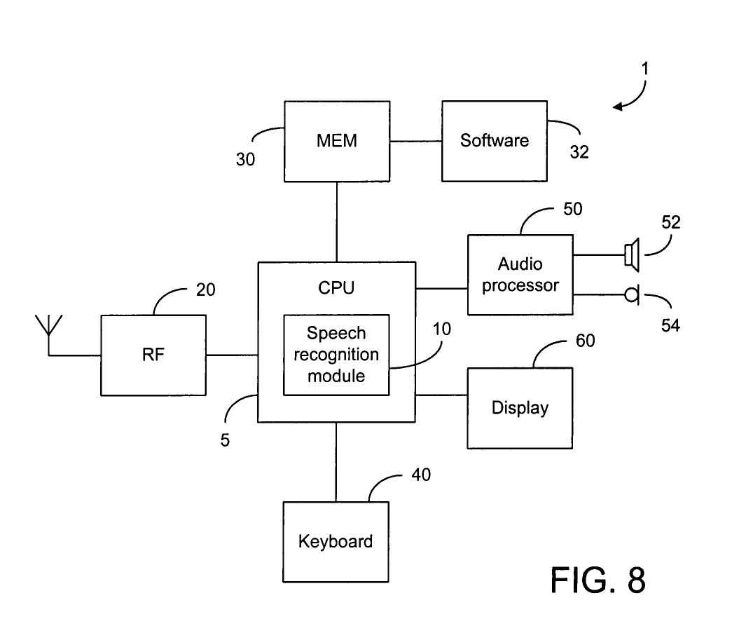

The speech recognition system 10 is particularly useful in an electronic device where limited memory capability and limited computation speed may be a limiting factor in speech recognition applications. As shown in FIG. 8, the exemplary electronic device 1 comprises a CPU 5 for data and signal processing. The electronic device may comprise an RF front-end 20 operatively connected to an antenna for communicating with other network components. The electronic device may also include other means for communicating with other devices, including both wired and wireless means. The electronic device may also be a stand-alone device, without any connections to other devices. The electronic device also comprises a speech recognition module 10, operatively connected to a keyboard for receiving vocabulary. The vocabulary can be displayed on a display 60, for example. The speech recognition module 10 is also connected to a voice input device 54 through an audio processor 50 for receiving a speech for recognition purposes. The vocabulary, the pronunciation trees, and the priority data can be stored in the memory module 30. The text-to-phonemes conversion algorithm and other software programs can be embedded in a computer readable medium 32. The computer readable medium 32 can be a part of the memory module 30. The electronic device 1 also has an audio signal input device, such as a microphone 52 for providing audio signal for speech recognition process. The electronic device can be a mobile terminal, for example.

Although the invention has been described with respect to one or more embodiments thereof, it will be understood by those skilled in the art that the foregoing and various other changes, omissions and deviations in the form and detail thereof may be made without departing from the scope of this invention.

What is claimed is:

1. A method of organizing grammars for use in an electronic device, the grammars having grammar items organized into trees of ordered branches, said method comprising:
ranking at least a part of the grammar items according to a grammar rule;
sorting at least part of the grammar items into grammar groups of different priority levels based at least partly on the ranking; and
building at least one tree separately for the grammar groups.

2. The method of claim 1, wherein the organized grammars are used at least in speech recognition.

3. The method of claim 1, wherein the trees built from the grammar items in the grammar groups at a higher priority level are at least partly used in speech recognition prior to the trees built from the grammar items in the grammar groups at a lower priority level.

4. The method of claim 3, wherein one or more trees are combined into a single concatenated tree for speech recognition and the number of trees combined in the concatenated tree is at least partly based on a time constraint.

5. The method of claim 3, wherein one or more trees are combined into a single concatenated tree for speech recognition and the number of trees combined in the concatenated tree is based at least partly on whether the speech recognition is carried out in real-time.

6. The method of claim 1, wherein the grammar items are words expressed in a string of phonemes, and the ordered branches are organized at least based on one or more phonemes similar among the strings in different words.

7. The method of claim 6, wherein the grammars are ranked at least based on the length of the string.

8. The method of claim 6, wherein the grammar items are ranked also based on the number of sub-branches on a branch.

9. A software program product embedded in a computer readable medium, the software product having executable codes for building trees of ordered branches from a plurality of grammar items of a plurality of ranks, wherein the executable codes, when executed, perform:
sorting the grammar items into grammar groups of different priority levels based at least partly on the ranks of the grammar items; and
building the trees at least partly separately for the grammar groups.

10. The software program product of claim 9, wherein the organized grammars are used at least in speech recognition.

11. The software program product of claim 9, wherein the executable codes further perform:
combining one or more trees into a single concatenated tree for speech recognition and the number of trees combined in the concatenated tree is at least partly based on a time constraint.

12. The software program product of claim 11, wherein the trees built from the grammar items in the grammar groups at a higher priority level are used at least partly prior to using the trees built from the grammar items in the grammar groups at a lower priority level in said combining.

13. The software program product of claim 9, wherein the grammar items are words expressed in a string of phonemes, and the ordered branches are organized at least based on one or more phonemes similar among the strings in different words.

14. The software program product of claim 13, wherein the grammars are ranked at least partly based on the length of the string.

15. The software program product of claim 13, wherein the grammar items are ranked at least partly based on the number of sub-branches on a branch.

16. A speech recognition system comprising:
a grammar management module for receiving grammar entries; and
a text-to-phonemes conversion module, operatively connected to the grammar management module, for converting the grammar entries into a plurality of phoneme strings, so as to allow the grammar management module to build a plurality of trees from the phoneme strings based at least partly on priority levels of the grammar entries.

17. The speech recognition system of claim 16, further comprising:
a software program for combining at least some of said plurality of trees into a concatenated tree having branches of phoneme strings.

18. The speech recognition system of claim 17, further comprising: a recognition algorithm for matching components in a speech signal with the phoneme strings in the concatenated tree.

19. An electronic device comprising:
a voice input to allow a user to input spoken words in the electronic device; and
a speech recognition system for recognizing the spoken words based on speech features of the spoken words, the system comprising:
a grammar management module for receiving grammar entries; and
a text-to-phonemes conversion module, operatively connected to the grammar management module, for converting the grammar entries into a plurality of phoneme strings, so as to allow the grammar management module to build a plurality of trees from the phoneme strings based at least partly on priority levels of the grammar entries and to combine at least some of the trees into a concatenated tree for matching the concatenated tree with the speech features.

20. The electronic device of claim 19, wherein the grammar entries are ranked at least partly based on the length of the string.

21. The electronic device of claim 19, wherein the grammar entries are ranked at least partly based on the number of sub-branches on a branch.

22. The electronic device of claim 19, wherein the number of trees combined in the concatenated tree is at least partly based on a time constraint in said speech recognition.

23. The electronic device of claim 19, wherein the number of trees combined in the concatenated tree is at least partly based on the computation power of the electronic device.

24. The electronic device of claim 19, comprising a mobile terminal.
